(19) United States
(12) Patent Application Publication
(10) Pub. No.: US 2007/0293250 A1
(43) Pub. Date: Dec. 20, 2007

(54) DMB DATA-BASED SHORT MESSAGING SYSTEM AND METHOD FOR A DIGITAL BROADCAST-ENABLED MOBILE PHONE

(75) Inventor: Kang Wook KIM, Metropolitan City (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/765,305

(22) Filed: Jun. 19, 2007

(30) Foreign Application Priority Data
Jun. 19, 2006 (KR) 2006-0054967

(51) Int. Cl. H04Q 7/20

(52) U.S. Cl. 455/466

(57) ABSTRACT

A Digital Multimedia Broadcasting (DMB) based short messaging system and method are provided for a digital broadcast-enabled mobile phone. A short messaging method for a mobile phone supporting digital broadcast service and a short message service includes receiving a broadcast stream; capturing a broadcast image from the broadcast stream; extracting text from the broadcast image; and composing a short message using the text.

### PRIORITY

This application claims priority to an application entitled “DMB DATA-BASED SHORT MESSAGING SYSTEM AND METHOD FOR A DIGITAL BROADCAST-ENABLED MOBILE PHONE” filed in the Korean Intellectual Property Office on Jun. 19, 2006 and assigned Serial No. 2006-0054967, the contents of which are incorporated herein by reference.

### BACKGROUND OF THE INVENTION

1. Field of the Invention

The present invention relates to a mobile terminal and, in particular, to a Digital Multimedia Broadcasting (DMB)-based short messaging system and method for a digital broadcast-enabled mobile phone.

2. Description of the Related Art

Typically, a mobile communication system provides various messaging services such as Short Message Service (SMS), Multimedia Message Service (MMS), Electronic mail (E-mail), and Motion Picture mail. In the meantime, recently emerged mobile phones are equipped with a Digital Multimedia Broadcasting (DMB) module.

DMB is a digital radio transmission system for sending multimedia (radio, TV, and datacasting) to mobile devices such as mobile phones.

DMB is based on the Digital Audio Broadcasting (DAB) standard, which is modified for transmitting digital audio, video, and multimedia streaming for mobile DMB receivers. DMB enables people to enjoy crystal-clear video, Compact Disc (CD) quality audio, and data via DMB exclusive terminals or hand-held devices such as mobile telephones, while moving. DMB services can be provided with plural video and audio channels and can be received by DMB receivers having an omnidirectional antenna.

There are two types of DMB: Terrestrial DMB (T-DMB) and Satellite DMB (S-DMB). T-DMB and S-DMB are roughly equal in terms of their mobile reception of multimedia broadcasts. The difference is that T-DMB works on networks built only through terrestrial broadcast stations, while S-DMB utilizes networks built with satellites and Gap Fillers, which provide in-building coverage.

Table 1 shows a comparison between the conventional broadcasting systems and DMB systems.

TABLE 1

Mobility

| | Non-support | Support | Comparison |
|---|---|---|---|
| Transmission | Terrestrial | T-DMB | Broadcast |
| | Broadcasting | | station |
| | Satellite | S-DMB | Satellite |
| | Broadcasting | | |
| Receiver | Large | Small | |

Typically, the DMB terminal is smaller than the conventional TV receiver.

S-DMB incorporates a high power geostationary satellite for outdoor coverage, integrated with a terrestrial repeater (low power gap-filler) network for indoor coverage in urban areas, while T-DMB utilizes terrestrial broadcast stations such as base stations of a cellular communication system.

FIG. 1 is a schematic block diagram illustrating a DMB system. Referring to FIG. 1, a DMB system includes a broadcasting center 110, at least one satellite 120 for S-DMB or at least one transmitter 130 for T-DMB, and DMB receivers 140, 150 and 160 such as an in-car terminal, a mobile handset and a personal computer equipped with a DMB receiver module, respectively.

The broadcasting center 110 compresses and modulates transmission data such as audio, video, and text data from a program that provides and then transmits the transmission signal to the satellite 120 or the transmitter 130. The satellite 120 or the transmitter 130 amplifies and frequency converts the transmission signal and then broadcasts the transmission signal on the air.

The transmission signal is received by the DMB receivers 140, 150 and 160. Each DMB receiver decompresses, demodulaties, and decodes the received transmission signal to recover the original transmission data.

With the deployment of the DMB network, the mobile phone users can enjoy crystal-clear video, CD-quality audio, and data on the move. As the number of subscribers continues to increase, operators are looking for ways to satisfy the subscriber's need for convenience.

In the meantime, Short Message Service (SMS) is one of the most popular ways to communicate using a mobile phone. Essentially, each SMS message is a short message that the subscriber types into a display of the mobile phone and sends to another mobile phone number. Recently, people are spending more on SMS as compared to voice services.

Since SMS uses a signaling channel as opposed to dedicated channels, these messages can be sent/received simultaneously with the voice and data service over a mobile communication network.

Some common applications of SMS are sending small messages along with a sending party number, and information services like news, weather, entertainment and stock prices.

Typically, an SMS message is written using a keypad provided with a plurality of alphanumeric keys, that is, the text message is composed with a series of alphanumeric key strokes.

When, however, a user wants to send an intended recipient the information obtained while using anther application such as the DMB, weather, new, and stock prices, the user must memorize or write the information on a sheet for composing a text message since the SMS message is not compatible with other application data, resulting in burdensome manipulation.

Accordingly, there has been a need for an improved messaging technique for compositing a message using data derived from another application service without alphanumeric key input, resulting in user convenience.

### SUMMARY OF THE INVENTION

The present invention has been made in an effort to solve the above problems, and it is an aspect of the present invention to provide a short messaging system and method for a mobile phone that are capable of composing a text message using a digital broadcast data.

It is another aspect of the present invention to provide a short messaging system and method for a DMB-enabled mobile phone that are capable of composing a text message by capturing digital broadcast data and converting the digital broadcast data into a short message service data.

It is another aspect of the present invention to provide a short messaging system and method for a DMB-enabled mobile phone that are capable of compositing a text message using text data extracted from digital broadcast data.

It is another aspect of the present invention to provide a short messaging system and method for a DMB-enabled mobile phone that are capable of delivering a text message extracted from digital broadcast data.

It is another aspect of the present invention to provide a short messaging system and method for a DMB-enabled mobile phone that are capable of facilitating composition of a text message by capturing digital broadcast data having a text caption and automatically assigning an index to the text caption.

It is another aspect of the present invention to provide a short messaging system and method for a DMB-enabled mobile phone that are capable of composing a text message having a title and a content selected from a caption extracted from captured digital broadcast data.

It is another aspect of the present invention to provide a short messaging system and method for a DMB-enabled mobile phone that are capable of composing a text message having a title and a content derived from a digital broadcast data and transmitting the text message through a short message service.

It is another aspect of the present invention to provide a short messaging system and method for a DMB-enabled mobile phone that are capable of composing and transmitting a text message having a title and a contents extracted from a digital broadcast data captured by a digital multimedia broadcast module.

It is another aspect of the present invention to provide a short messaging system and method for a DMB-enabled mobile phone that are capable of composing a text message by modifying a size of text data extracted from digital broadcast data captured by a digital multimedia broadcast module so as to be appropriate for a short message service format.

In accordance with an aspect of the present invention, the above and other objects are accomplished by a short messaging method for a mobile phone supporting digital broadcast service and a short message service. The short messaging method includes receiving a broadcast stream; capturing a broadcast image from the broadcast stream; extracting a text from the broadcast image; and composing a short message using the text.

In accordance with another aspect of the present invention, the above and other objects are accomplished by a short messaging method for a mobile phone supporting a digital broadcast service and a short message service. The short messaging method includes capturing, if a specific event occurs, broadcast data from a broadcast stream; extracting a text from the broadcast data; displaying the text on a short message composition screen; composing a short message using the text; and transmitting the short message through a short message service.

In accordance with another aspect of the present invention, the above and other objects are accomplished by a short messaging system. The short messaging system includes a first mobile phone, having a digital broadcast module for receiving a broadcast stream and a short message module for composing a short message using a caption included in the broadcast stream and transmitting the short message; and a second mobile phone receiving the short message and displaying the short message.

In accordance with another aspect of the present invention, the above and other objects are accomplished by a mobile phone that includes a multimedia processing unit for receiving a broadcast stream, and separating video, audio, and caption signals from the broadcast stream; a short message processing unit for capturing a broadcast image from the broadcast stream in accordance with a preset configuration and composing a short message using the captured broadcast image; and a controller for controlling a cooperation of the multimedia processing unit and the short message processing unit to detect a character string in the broadcast stream, capture the broadcast image, extract a text from the broadcast image, and compose the short message using the text, according to the preset configuration.

### BRIEF DESCRIPTION OF THE DRAWINGS

The above and other objects, features and advantages of the present invention will be more apparent from the following detailed description in conjunction with the accompanying drawings, in which:

FIG. 1 is a schematic block diagram illustrating a DMB system;

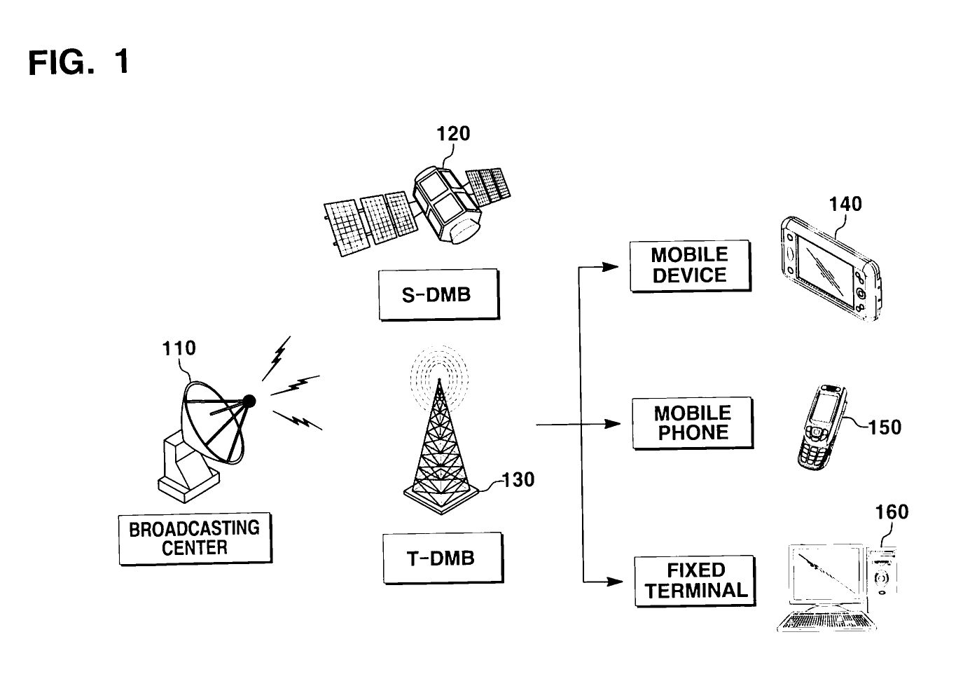

FIG. 2 illustrates a configuration of a short messaging system according to an exemplary embodiment of the present invention;

FIG. 3 is a block diagram illustrating a configuration of a mobile terminal according to an exemplary embodiment of the present invention;

FIG. 4 is a block diagram illustrating a configuration of a mobile phone according to an exemplary embodiment of the present invention;

FIG. 5 is a block diagram illustrating a configuration of a mobile communication system of the short messaging system of FIG. 2;

FIG. 6 is a message flow diagram illustrating a DMB data-based short messaging system according to an exemplary embodiment of the present invention;

FIG. 7 is a flowchart illustrating a DMB data-based short messaging method according to an exemplary embodiment of the present invention;

FIG. 8 illustrates a short message composition process in a DMB-data based short message system according to an exemplary embodiment of the present invention; and

FIG. 9 is a flowchart illustrating a DMB data-based short messaging method according to an exemplary embodiment of the present invention.

### DETAILED DESCRIPTION OF PREFERRED EMBODIMENTS

Preferred embodiments of the present invention are described with reference to the accompanying drawings in detail. The same reference numbers are used throughout the drawings to refer to the same or like parts. Detailed descriptions of well-know functions and structures incorporated herein are omitted to avoid obscuring the subject matter of the present invention.

In the following detailed description, exemplary embodiments have been shown and described to illustrate of the best mode contemplated to carry out the invention. As will be realized, the invention is capable of modification in various obvious respects, all without departing from the invention. Accordingly, the drawings and description are illustrative in nature and not restrictive.

A short messaging system and method of the present invention may be adopted by a Digital Multimedia Broadcasting (DMB)-enabled mobile phone enabled compose a text message for Short Message Service (SMS) or electronic mail (E-mail) using broadcast data received by a DMB module of the mobile phone.

The SMS message or E-mail composed in such a manner is transmitted to an intended recipient through a mobile communication network. That is, the short messaging system and method of the present invention enable the user to capture DMB data while viewing a real time DMB program and convert the captured DMB data into a text message for SMS.

The DMB-enabled mobile phone captures DMB data while viewing the DMB program in accordance with a user command, extracts text data from the captured DMB data, and automatically indexes the text data, such that the user composes a short message with reference to the indexes.

The short message composed in such a manner is transmitted over a message transmission service such as SMS. A size of the short message can be automatically resized to fit the message transmission service.

That is, the DMB-enabled mobile phone captures and stores the DMB data in accordance with a capturing configuration set by the user, automatically composes a short message with text data contained in the captured DMB data, and provides the short message for SMS transmission.

The text data is a caption provided with the DMB data and automatically indexed to facilitate editing the short message composed on the basis of the DMB data. The short message can be transmitted using a message transmission service such as SMS in cooperation with the mobile communication system.

To simplify explanation, the short messaging system and method is described in association with a DMB-enabled mobile phone, however, the present invention is not limited thereto, but can be adapted to portable devices such as a digital broadcasting receiver, Personal Digital Assistant (PDA), laptop computer and Smartphone. Also, the mobile phone can be a 3^{rd} generation terminal, Code Division Multiple Access (CDMA) terminal, Global System for Mobile communication (GSM) terminal, Wireless Local Area Network (WLAN) terminal, Wireless Broadband (WiBro) Terminal, and High Speed Downlink Packet Access (HSDPA) terminal.

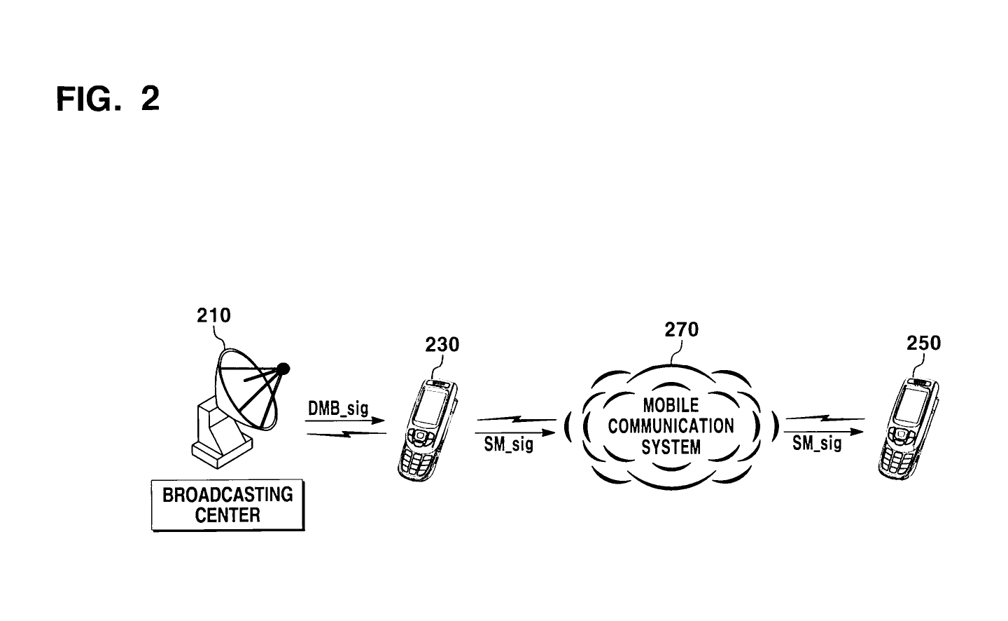

FIG. 2 illustrates a configuration of a short messaging system according to an exemplary embodiment of the present invention. Referring to FIG. 2, the short messaging system according to an exemplary embodiment of the present invention includes a broadcasting center 210, a first mobile phone 230 as a sending party, a second mobile phone 250 as a called party, and a mobile communication system 270.

The broadcasting center 210 performs compression and modulation on audio, video, and text data to generate DMB data (DMB_sig) and broadcasts DMB_sig.

Preferably, the broadcasting center 210 transmits DMB_sig to a broadcasting satellite (S-DMB) or a land-based transmitting station (T-DMB) that broadcasts the DMB_sig. The DMB_sig is amplified, frequency-converted and then broadcast by the satellite or the transmitting station.

While receiving DMB_sig, the first mobile phone 230 captures DMB_sig according to a user command and generates a DMB file (DMB_sig′) from the captured DMB_sig. The first mobile phone 230 converts DMB_sig′ into a short message (SM_sig) to be transmitted using a messaging service such as a Short Message Service (SMS). SM_sig is transmitted to the second mobile phone 250, i.e. an intended recipient, through SMS of the mobile communication system 270.

The first mobile phone 230 extracts text data from DMB_sig′ and indexes the text data in association with a title and content of SM_sig so as to generate SM_sig.

SM_sig includes the text data extracted from DMB_sig′ and information on the intended recipient, i.e. the second mobile phone 250. The information on the intended recipient can be a phone number.

The second mobile phone 250 receives SM_sig in the form of SMS message so as to recognize the data contained in SM_sig. The received SM_sig is presented with support of the activation of SMS application provided by the second mobile phone 250. The second mobile phone 250, i.e. the recipient device, is preferably a DMB-enabled mobile phone, but can be a typical mobile phone that does not support DMB service.

The mobile communication system 270 includes various network elements such as base stations, billing center, message service center, etc. that cooperate to support communication between the mobile phones 230 and 250.

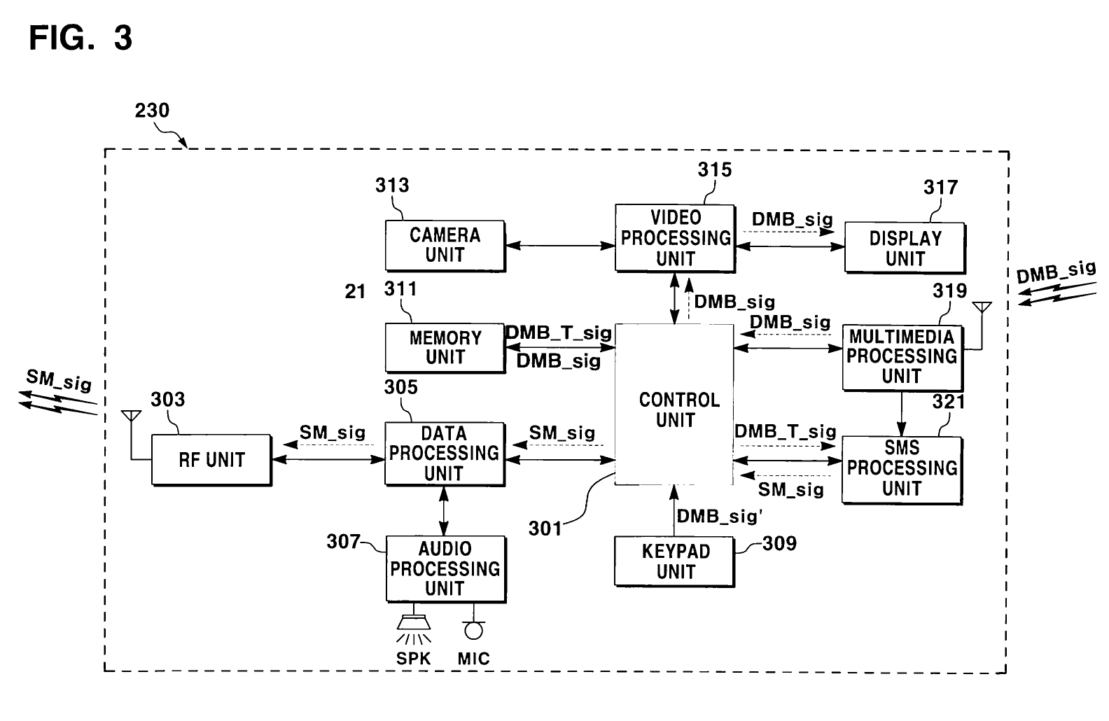

FIG. 3 is a block diagram illustrating a configuration of a mobile terminal according to an exemplary embodiment of the present invention. In this embodiment, the mobile terminal is a DMB-enabled mobile terminal representing the first and second mobile terminals 230 and 250 of FIG. 2, which are capable of receiving DMB_sig broadcast by the broadcasting center 210, converting DMB_sig into SM_sig, and transmitting SM_sig to an intended recipient through SMS service.

Referring to FIG. 3, the first mobile phone 230 includes a control unit 301, a Radio Frequency (RF) unit 303, a data processing unit 305, an audio processing unit 307, a keypad unit 309, a memory unit 311, a camera unit 313, a video processing unit 315, a display unit 317, a multimedia processing unit 319 and an SMS processing unit 321.

These elements constituting the mobile phone 230 can be classified into an input means, a processing means, a storage means, an output means and a communication means.

The input means is responsible for furnishing alphanumeric and multimedia data. The input means includes the audio processing unit 307, keypad unit 309 and camera unit 313. The display unit 317 can be implemented with a touchscreen Liquid Crystal Display (LCD). In this case the display unit 317 can also be included in the input means.

The processing means is responsible for processing user data such as voice, alphanumeric and image data input through the input means, and application data generated in association with the various applications such as DMB and SMS. The processing means includes the data processing unit 305, video processing unit 315, multimedia processing unit 319, SMS processing unit 321 and control unit 301.

The storage means is responsible for storing the user data input through input means and application programs for additional functions such as DMB and SMS. The storage means includes the memory unit 311.

The output means is responsible for outputting the user data input through the input means or read from the storage means and application data provided by the application programs. The output means includes the audio processing unit 307 and the display unit 317.

The communication means is responsible for enabling the first mobile phone 230 to communicate with a counterpart terminal through the mobile communication network. The communication means includes the RF unit 303 and at least one antenna.

The RF unit 303 is implemented to process radio signals exchanged between the first mobile phone 230 and a base station (not shown). The RF unit 303 converts a base band signal to be transmitted into a radio frequency signal and converts a received radio frequency signal into a baseband signal. The RF unit 303 includes an RF transmitter for up-converting and amplifying the base band signal to be transmitted and an RF receiver for low noise amplifying and down-converting the received radio frequency signal.

The mobile communication network can be any of systems based on technologies such as Code Division Multiple Access (CDMA), Time Division Multiple Access (TDMA), Wideband CDMA (WCDMA), and Orthogonal Frequency Division Multiple Access (OFDMA).

A communication channel between the mobile terminals can be established through at least two different communication networks, for example a combination of a CDMA and Wireless Broadband (WiBro) networks.

The communication channel includes a data channel for voice and data transmission and control channels including a paging channel on which SMS message is transmitted.

The data processing unit 305 is responsible for processing audio data output from the audio processing unit 307 and alphanumeric data input through the keypad unit 309. The data processing unit 305 can be implemented with a codec for performing encoding/decoding and a modem for performing modulation/demodulation on signals to and from the RF unit 303, including the SM_sig.

The codec can include a data codec for processing packet data and an audio codec for processing audio data including voice data.

The audio processing unit 307 processes the audio data from the data processing unit 305 and the multimedia processing unit 319 to output the audio data as an audible sound wave through a speaker (SPK), and processes a signal input through a microphone (MIC) to output audio data to the data processing unit 305.

The keypad unit 309 is provided with a plurality of alphanumeric keys for furnishing user input data and various function keys for executing specific operations. The keypad unit 309 is implemented for supporting a short messaging function with the DMB data (DMB_sig) under the control of the controller 301. The function keys can be implemented in the form of soft keys or shortcut keys.

In more detail, the keypad unit 309 enables input of commands for capturing DMB_sig′ from DMB_sig received through the multimedia processing unit 319, composing SM_sig on the basis of the DMB_sig′, and transmitting the SM_sig.

The memory unit 311 includes a program memory and a data memory. The program memory stores an operating system for controlling general operations of the first mobile phone 230 and application programs for executing specific functions such as DMB and SMS, particularly in regard to interoperability between the DMB and SMS functionalities in this embodiment.

The memory unit 311 also stores DMB_sig′ generated by capturing the real time DMB_sig in accordance with a predetermined function by the control unit 301. DMB_sig′ is a screen image captured at a specific time point. DMB_sig′ may include text information and DMB caption (DMB_T_sig).

DMB_sig′ is captured at a time point when a capture key is input through the keypad unit 309, when a preset subject is recognized from DMB_sig, or when a specific time is reached or a preset text is recognized from DMB_sig when an automatic capture function is set. DMB_sig′ is stored within the memory unit 311 under the control of the control unit 301.

The data memory stores application data generated while the application programs are executed and configuration parameters and information in association with the DMB service, and particularly the short message-compositing function with captured DMB data stored in database form.

The memory unit 311 also stores a dedicated DMB data-based short message composition application that includes a data collection module for collecting video, audio, and broadcast information provided for the DMB service in accordance with key inputs; a screen capture module for selectively capturing and storing the DMB data in accordance with user's request; a text extraction module for extracting text from the captured DMB data; an indexing module for assigning indexes to the extracted DMB data; a resizing module for analyzing a size of the captured DMB data and modifying the size of the DMB data to be fit for SMS transmission; a short message generation module for converting the DMB data into at least one short message; and a control module for checking a configuration set for capturing DMB data, detecting text from the DMB data in accordance with the configuration, and controlling the conversion of the DMB data into the short message. These program modules are preferably implemented in the form of Flash files.

The camera unit 313 takes a picture and outputs the picture as a video signal. In order to generate the video signal, the camera unit 313 includes a camera sensor for converting an optical signal input through a lens into an electric signal and a signal processer for converting the electrical signal into a digital signal.

The camera sensor is implemented with a Charge Coupled Device (CCD) or a Complementary Metal Oxide Semiconductor (CMOS) sensor, and the signal processor is implemented with a Digital Signal Processor (DSP). Also, the camera sensor and the signal processor can be integrated as a single module.

The video processing unit 315 processes the application data image and menu screen image to be suitable for the display unit 317 and then transmits the processed images to the display unit 317 under the control of the control unit 301. The video processing unit 315 processes the DMB_sig and screen image to fit the display unit 317.

The video processing unit 315 processes the video data by frame such that the video data are output to the display unit 317 in an appropriate size and format. The video processing unit 315 also processes DMB_sig delivered from the multimedia processing unit 319 and DMB-sig′ captured from DMB_sig to be output to the display unit 317 in an appropriate size and format.

The video processing unit 315 processes the SM_sig composed using the DMB_sig′ to be output to the display unit 317 in an appropriate size and format.

The video processing unit 315 includes a video codec that performs compression and decompression on the video data by frame. The video codec preferably includes a Joint Photographic Experts Group (JPEG) codec, a Moving Picture Experts Group (MPEG)-4 codec, and a Wavelet codec.

The display unit 317 presents the video data output from the video processing unit 315, user data input through the keypad unit 309, and an application execution screen. The display unit 317 can be implemented with a Liquid Crystal Display (LCD).

The display unit 317 also presents DMB application execution screens and menus associated with the audio and video channels and functional options. The display unit 317 displays the real time stream of DMB_sig and a channel selection screen for selecting a DMB channel.

The display unit 317 displays SM_sig composed using DMB_sig′ captured from DMB_sig. SM_sig is a text or caption (DMB_T_sig) extracted from DMB_sig′ together with indexes.

The multimedia processing unit 319 recognizes a type of the DMB service, i.e. S-DMB and T-DMB requested by the user and sets its radio interface for receiving DMB data of the requested DMB service.

The multimedia processing unit 319 cooperates with one or both of the video processing unit 315 and the audio processing unit 307.

The multimedia processing unit 319 receives DMB_sig broadcast from the broadcasting center. The multimedia processing unit 319 can operate as an S-DMB receiver and a T-DMB receiver. That is, the multimedia processing unit 319 can be implemented as a dual mode DMB receiver capable of receiving T-DMB and S-DMB_signals.

In this embodiment, the multimedia processing unit 319 is described only with DMB related function. However, the multimedia processing unit 319 can be implemented with the DMB-based short message composition functions including capturing DMB_sig′ from DMB_sig, extracting SM_sig from DMB_sig′, and editing SM_sig to be transmitted through SMS.

Preferably, the multimedia processing unit 319 can be implemented with an additional communication module for SMS transmission. Also, the multimedia processing unit 319 can be implemented as a separate device such that the SM_sig is composed in the separate device and then transmitted to another communication terminal supporting SMS transmission.

When the multimedia processing unit 319 is implemented as a separate device, it should provide a connection interface for supplying the DMB data received from the broadcasting center to a mobile terminal or a television. Of course, the separate multimedia processing unit can include a keypad for inputting user data and commands, a storage unit for storing the DMB data and the user data, a video/audio processing unit for processing the DMB data and an output part including a speaker and display for outputting video and audio data extracted from the DMB data.

The SMS processing unit 321 extracts text, i.e. a caption (DMB_T_sig) from DMB_sig′ and composes a short message (SM_sig) using the DMB_T_sig.

The SMS processing unit 321 reads DMB_sig′ from the memory unit 311. The DMB_sig′ is captured and stored in accordance with the user request.

The SMS processing unit 321 extracts DMB_T_sig from DMB_sig′ and classifies the text of DMB_T_sig into a title and content. The title and content are indexed such that the SM_sig is composed together with indexes and transmitted through SMS.

In this embodiment, a short message (SM_sig) is composed with a caption (DMB_T_sig) extracted from a DMB file (DMB_sig′) captured from DMB data (DMB_sig) together with indexes of a title and a content.

Preferably, SM_sig includes a phone number of a sending party.

The control unit 301 controls cooperation between the units constituting the first mobile phone 230. The control unit 301 can be integrated with the data processing unit 305. The control unit 301 controls cooperative signaling among the data processing unit 305, keypad unit 309, memory unit 311, camera unit 313, video processing unit 315, multimedia processing unit 319 and SMS processing unit 321.

Particularly, the control unit 301 controls cooperation between the multimedia processing unit 319 and the SMS processing unit 321 for composing an SMS message using DMB data received by the multimedia processing unit 319.

The control unit 301 controls change of an operation mode of the first mobile phone 230 in accordance with a user command. For example, if a multimedia mode selection signal is input through the keypad unit 309, the control unit 301 changes the operation mode and sets a configuration of the first mobile phone 230 for receiving the DMB data. The control unit 301 controls the display unit 317 to present operational screens of the applications and user data.

The control unit 301 controls the multimedia processing unit 319 to capture a DMB file from a real time DMB stream, store the DMB file, extract a text from the DMB file, and generate a short message using the text, in accordance with a user's request.

The multimedia processing unit 319 captures DMB_sig′ from the real time DMB_sig, extracts DMB_T_sig from the DMB_sig′, composes SM_sig using the DMB_T_sig, and delivers the SM_sig to the SMS processing unit 321.

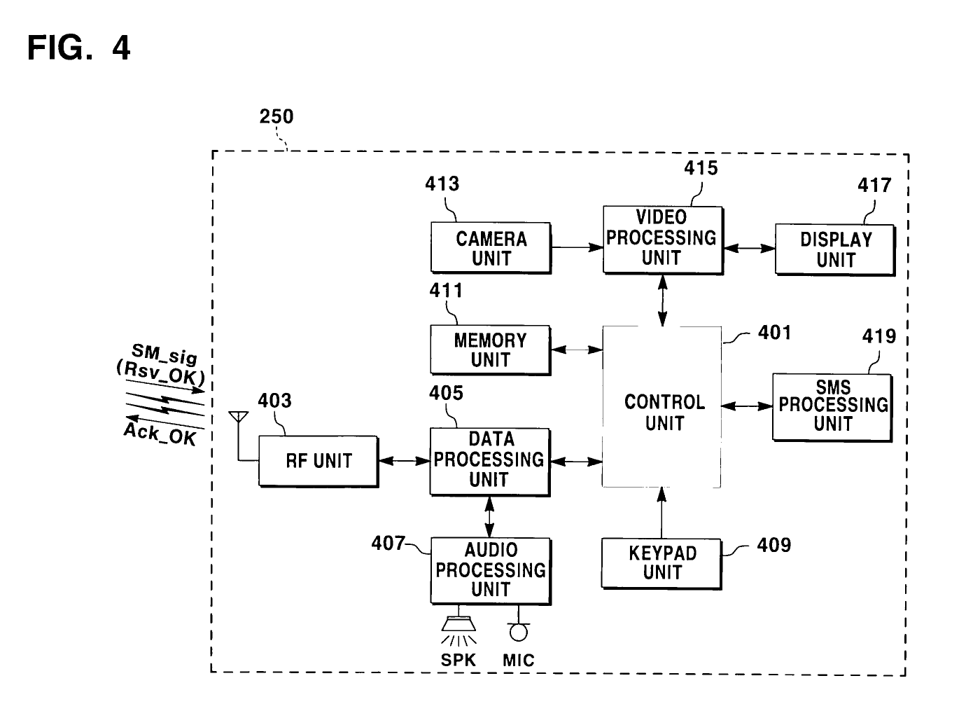

FIG. 4 is a block diagram illustrating a configuration of a mobile phone according to an exemplary embodiment of the present invention. In this embodiment, the mobile terminal represents the second mobile phone 250 having no DMB function. Of course, the second mobile phone 250 can be a DMB-enabled mobile phone having the configuration of FIG. 3.

The following description assumes that the second mobile phone 250 of FIG. 4 receives SM_sig transmitted from the first mobile phone 230 so as to inform the recipient of the DMB information. keypad unit 409, a memory unit 411, a camera unit 413, a video processing unit 415, a display unit 417 and an SMS processing unit 419.

Detailed descriptions of functions and structures identical with those of the first mobile phone 230 of FIG. 3 are omitted hereinafter. The second mobile phone 250 receives an SMS message from the first mobile phone 230.

Referring to FIG. 4, the second mobile phone 250 receives SM_sig together with a reception request signal (Rsv_OK) through the RF unit 403. If the second mobile phone 250 is instructed to receive the SM_sig by the user, it transmits an acknowledgement signal (Ack_OK) to the mobile communication system 270. Upon receiving the Ack_OK, a message service center of the mobile communication system 270 transmits a short message signal (MM_sig).

Rsv_OK and Ack_OK, can be exchanged through SMS or MMS, however, it is preferred to use SMS in consideration of cost.

The data processing unit 405 can include a codec for performing encoding/decoding and a modem for performing modulation/demodulation on the signals to and from the RF unit 403 including Ack_OK, Rsv_OK and SM_sig.

The audio processing unit 407 processes the audio data from the data processing unit 405 so as to output the audio data as an audible sound wave through a speaker (SPK), and processes a signal input through a microphone (MIC) to output as audio data to the data processing unit 405.

The keypad unit 409 is provided with a plurality of alphanumeric keys for furnishing user input data and various function keys for executing specific operations. The keypad unit 409 enables input of commands for receiving SM_sig and managing SM_sig while a user views SM_sig on a screen of the display unit 417.

The memory unit 411 can include a program memory and a data memory. The program memory stores an operating system for controlling general operations of the second mobile phone 250 and application programs for executing specific functions, particularly an application for providing SMS service. The SM_sig can be stored temporarily or semipermanently within the memory unit 411. Of course, stored SM_sig can be deleted by the user.

The control unit 401 controls general operations of the second mobile phone 250 and cooperative signaling among the data processing unit 405, keypad unit 409, memory unit 411, video processing unit 415 and SMS processing unit 419.

The control unit 401 controls change to an operation mode of the second mobile phone 250 in accordance with a user command. For example, if an SMS mode selection signal is input through the keypad unit 409, the control unit 401 changes the operation mode to an SMS mode and sets a configuration for the second mobile phone 250 for reading or writing SM_sig. The control unit 401 also controls the display unit 417 to present operational screens of the applications and user data.

The video processing unit 415 converts an input analog image into a digital video signal and outputs the digital video signal to the

The video processing unit 415 converts an input analog image into a digital video signal and outputs the digital video signal to the display unit 417. The video processing unit 415 outputs a short message of SM_sig in the format appropriate for the display unit 417.

The display unit 417 presents SM_sig output from the video processing unit 415. The display unit 417 also presents operational screens of the application for providing additional services like SMS, and DMB caption (DMB_T_sig) received in the form of a short message, under the control of the control unit 401.

The display unit 417 also presents the SMS message (SM_sig) received from the mobile communication network and controls messages such as Rsv_OK, and Ack_OK associated with SMS.

The SMS processing unit 419 processes application data associated with various additional functions such as SMS. The SMS processing unit 419 processes text data of SM_sig received through SMS so as to be presented on the display unit 417.

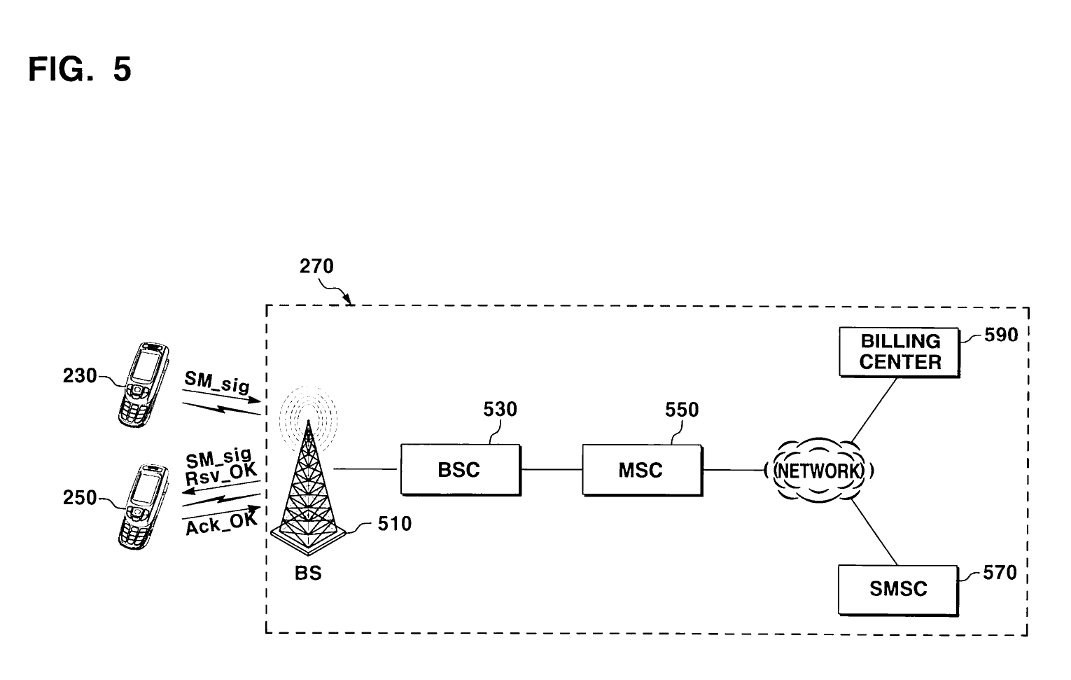

FIG. 5 is a block diagram illustrating a configuration of a mobile communication system of the short messaging system of FIG. 2. Referring to FIG. 5, a mobile communication system 270 receives and stores SM_sig received from the first mobile phone 230 and forwards the SM_sig to the second mobile phone 250.

The mobile communication system 270 includes a Base Station (BS) 510, a Base Station Controller (BSC) 530, a Mobile Switching Center (MSC) 550, a Short Message Service Center (SMSC) 570 and a billing center 590. responsible for connecting the mobile phones 230 and 250 to a backbone of the mobile communication system 270.

The BSC 530 is interconnected between the BS 510 and the MSC 550. The BSC 530 is responsible for radio resource allocation to the mobile phones 230 and 250, frequency administration, power control and handover between BSs.

The MSC 550 is responsible for setting up, routing and supervising of calls to and from the mobile phones 230 and 250. The MSC 550 also has the functionality to store subscriber information, such as location information and supplementary services, such as call diverts and call waiting The MSC 550 routes a short message (SM_sig) transmitted by the first mobile phone 230 to the SMSC 570.

The SMSC 570 is responsible for handling the SMS operations of the mobile communication system 270, i.e. it stores SM_sig received from the first mobile phone 230 and forwards the SM_sig to the second mobile phone 250. The SM_sig includes a reception request message (Rsv_OK) that may contain a part or whole DMB caption (DMB_T_sig).

That is, the SMSC 570 sends the SM_sig to the second mobile phone 250 together with a brief description containing a part or whole of the DMB caption (DMB_T_sig) in the form of Rsv_OK.

Accordingly, the recipient can recognize the content of the SM_sig. Rsv_OK can be prepared and transmitted using a messaging service like SMS.

The billing center 590 accounts for incoming and outgoing calls including the SM_sig on the first and second mobile phones 230 and 250. In a case of SM_sig accounting, the billing center 590 may charge the cost of SM_sig to the first mobile phone 230, i.e. the sender, or the second mobile phone 250, i.e. the recipient, or to both the first and second mobile phones 230 and 250.

A captured DMB data-based short messaging method is described hereinafter with reference to the accompanying drawings. The captured DMB data-based short messaging method can be divided into an SMS processing part and a DMB data processing part.

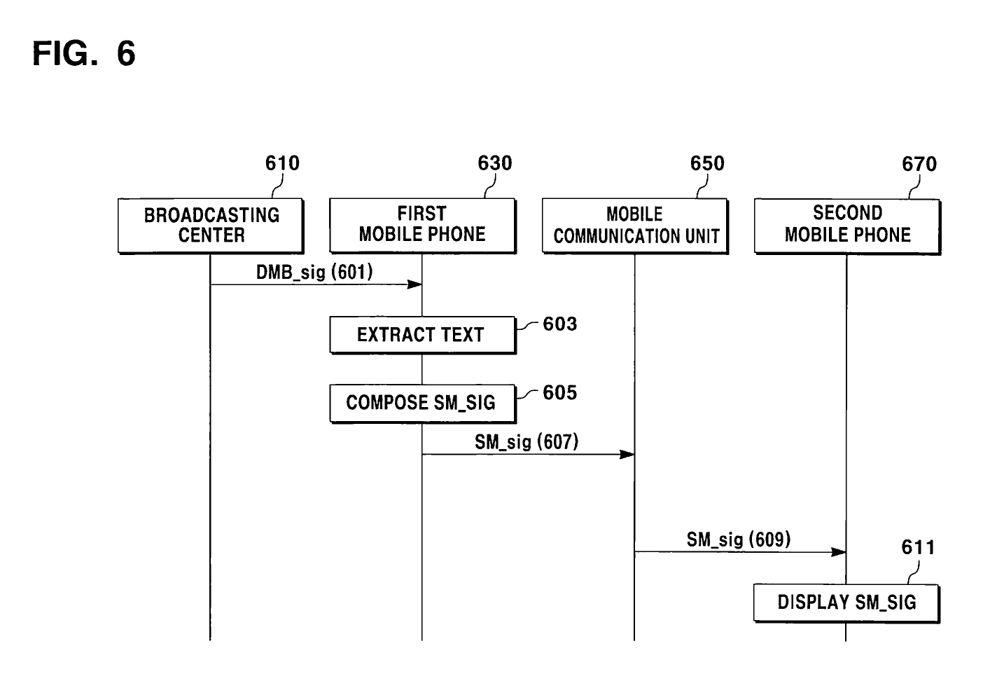

FIG. 6 is a message flow diagram illustrating a DMB data-based short messaging system according to an exemplary embodiment of the present invention. Referring to FIG. 6, in the DMB data-based short messaging system, a first mobile phone 630 receives DMB data (DMB_sig) from a broadcasting center 610 (S601). The first mobile phone 630 includes an S-DMB and a T-DMB receiver for selectively receiving a DMB_signal (DMB_sig) from a satellite or a T-DMB transmitter. In this embodiment, it is assumed that the DMB data (DMB_sig) includes a caption.

While receiving the DMB_sig, the first mobile phone 630 captures a screen image (DMB_sig′) in accordance with a user instruction and extracts text, i.e. a character string, from the DMB_sig′ (S603).

The screen image (DMB_sig′) is captured from the DMB data received in real time in accordance with an event, e.g. when a key for executing a screen capture function is input. The captured screen image (DMB_sig′) is temporarily stored such that the DMB caption (DMB_T_sig) is extracted from the DMB_sig′ according to a user command.

The DMB caption (DMB_T_sig) is text provided with DMB video data on the screen. Typically, the DMB caption is presented at one side of the screen, e.g. a top or a bottom side. In this embodiment, the DMB caption is provided as indexes of a title and content of a short message (SM_sig).

After the text (DMB_T_sig) is extracted from the screen image (DMB_sig′), the first mobile terminal 630 composes a short message (SM_sig) using the text (DMB_T_sig) in Step 605.

At Step 605, the first mobile phone 630 automatically composes the short message (SM_sig) consisting of a title and content using the DMB caption (DMB_T_sig) stored in the memory.

Particularly, the short message (SM_sig) is composed by an SMS processing unit of the first mobile phone 630. The SMS processing unit analyzes a length of the DMB caption (DMB_T_sig) and determines whether the DMB caption is shorter than an SMS length limit. If the length of the DMB caption is longer than the SMS length limit, the SMS processing unit downsizes the length of the DMB caption (DMB_T_sig).

For example, if the length of the DMB caption (DMB_T_sig) is longer than the SMS length limit, the SMS processing unit can divide the DMB caption (DMB_T_sig) into at least two pieces that are converted into respective short messages, or cut off a redundant portion of the DMB caption such that the DMB caption can be converted into the short message.

When the short message is completely composed, the first mobile phone 630 transmits the short message (SM_sig) to a mobile communication system 650 along with a phone number of a second mobile phone 670 in Step 607.

In more detail, the short message (SM_sig) transmitted by the first mobile phone 630 is delivered to the SMSC 570 through the BS 510, BSC 530, and MSC 550 (see FIG. 5). Upon receiving the short message (SM_sig), the SMSC 570 checks a destination phone number contained in the short message (SM_sig). At this time, the billing center 590 can perform a billing function to the first mobile phone 630.

When the destination phone number is checked, the mobile communication system 650 transmits a reception request message (Rsv_OK) to the second mobile phone 670. The reception request (Rsv_OK) can be transmitted along with a brief description of the short message (SM_sig) so the recipient can decide whether to receive the short message (SM_sig). If a message reception is rejected by the recipient, the second mobile phone 670 does not receive the short message (SM_sig).

If the recipient checks the brief description of the reception request message (Rsv_OK) and decides to receive the short message (SM_sig), the second mobile phone 670 transmits an acknowledgement message (Ack_OK) to the mobile communication system 650.

If the acknowledgement message (Ack_OK) is received, the mobile communication system 650 forwards the short message (SM_sig) to the second mobile phone 670 in Step 609. The short message is transmitted by the SMSC 570 of the mobile communication system 650. Along with the short message transmission, the billing center 590 can perform a billing function.

Upon receiving the short message (SM_sig), the second mobile phone 670 presents the short message (SM_sig) on a display screen and stores the short message within a memory in accordance with an input of a save command in Step 611.

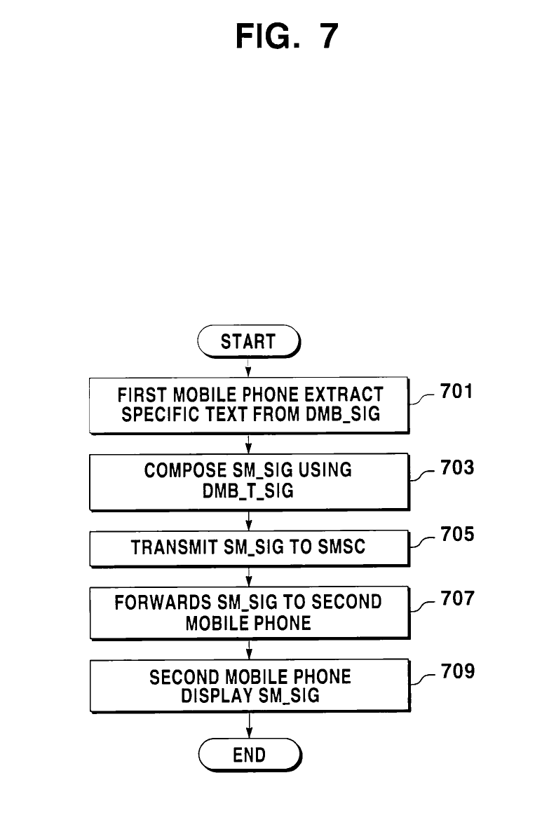

FIG. 7 is a flowchart illustrating a DMB data-based short messaging method according to an exemplary embodiment of the present invention. Referring to FIG. 7, a first mobile phone captures a DMB image (DMB_sig′) from a real time DMB data (DMB_sig) stream and extracts a text, i.e. a DMB caption (DMB_T_sig), from the captured DMB image (DMB_sig′) in Step 701.

Next, the first mobile phone composes a short message using the DMB caption (DMB_T_sig) in Step 703. In more detail, the first mobile phone extracts a part of or the entire DMB caption (DMB_T_sig) and presents the extracted text as the short message (SM_sig) on an SMS application screen.

After the short message (SM_sig) is composed, the first mobile phone transmits the short message (SM_sig) to the mobile communication system in Step 705.

The mobile communication system forwards the short message (SM_sig) to the second mobile phone in Step 707. At this time, the mobile communication system allows the second mobile phone to decide whether to receive the short message.

Upon receiving the short message, the second mobile phone presents the received short message on an SMS application screen and stores in a memory in accordance with the user command in Step 709.

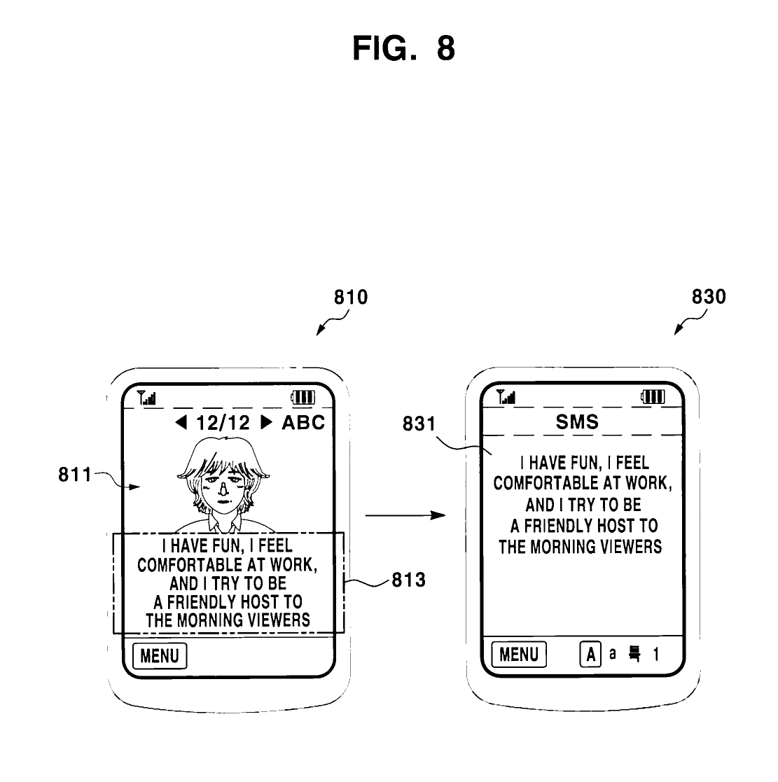

FIG. 8 illustrates a short message composition process in a DMB-data based short message system according to an exemplary embodiment of the present invention. Referring to FIG. 8, reference numeral 810 denotes a DMB screen showing a DMB image 811 captured from a DMB stream received by a mobile phone, and reference numeral 830 denotes an SMS screen showing a short message 831 composed using a caption 813 contained in the captured DMB image 811.

The mobile phone receives broadcast signals from a broadcasting center, converts the broadcast signals into a DMB stream, and then displays the DMB stream on the DMB screen so that a user can watch the DMB stream as a motion picture.

If an event occurs while displaying the DMB stream, i.e. a DMB capture function key is input, the mobile phone captures a DMB image (DMB_sig′) 811 from the DMB stream (DMB_sig) and displays the captured DMB image (DMB_sig′) 811 on the display screen. The DMB capture is preferably performed at a time point when the mobile phone recognizes a specific character string registered by the user.

The mobile phone extracts the caption (DMB_T_sig) 813 from the captured DMB image (DMB_sig′) and then composes a short message (SM_sig) 831 using the extracted caption (DMB_T_sig).

For example, the mobile phone extracts the caption “I have fun, I feel comfortable at work, and I try to be a friendly host to the morning viewers” from the captured DMB image (DMB_sig′) and automatically composes the short message using the caption as in the SMS screen 830.

Further, the automatically composed short message can be edited by the user.

The caption (DMB_T_sig) is preferably resized to fit the SMS length limit while being translated into the short message (SM_sig). For example, if the length of the caption is longer than the SMS length limit, the caption is divided into at least two pieces to be generated as individual short messages.

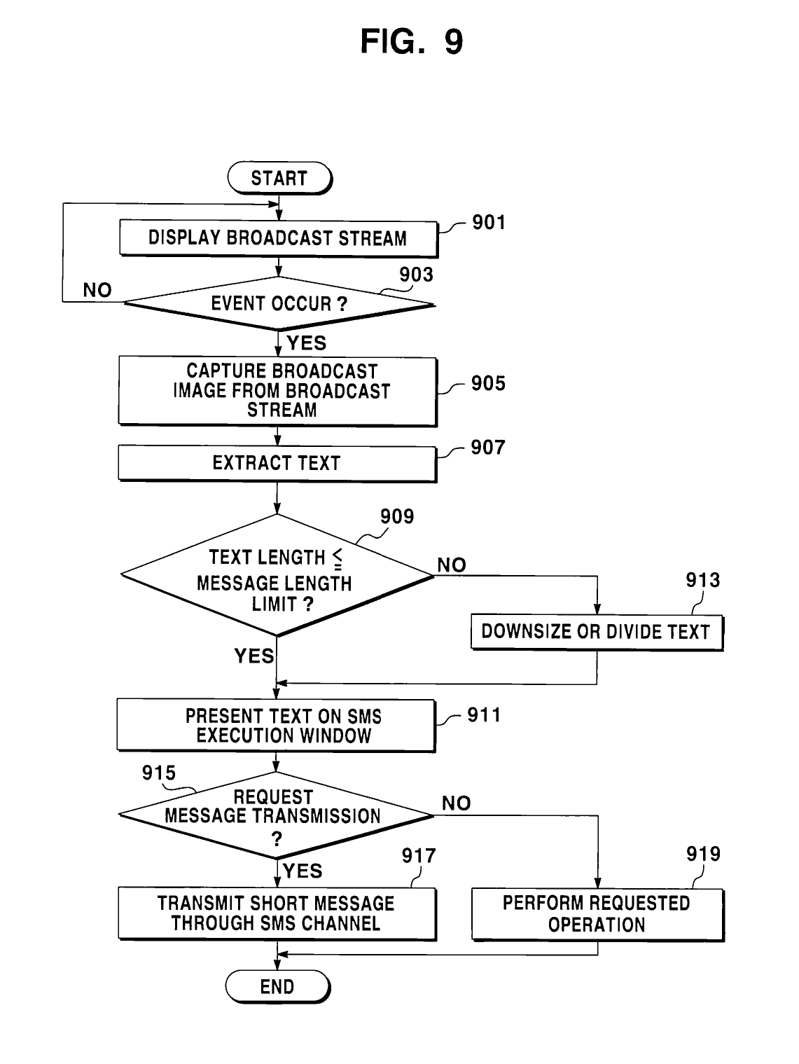

FIG. 9 is a flowchart illustrating a DMB data-based short messaging method according to an exemplary embodiment of the present invention. Referring to FIG. 9, mobile phone receives a DMB stream from a broadcasting center and displays the received DMB stream on a display screen in Step 901.

While displaying the DMB stream, the mobile phone monitors an occurrence of a specific event in Step 903. The specific event can be a key input for capturing a DMB image from the DMB stream and a detection of a character string, registered by the user, from a caption provided with the DMB stream. These events are referred to as a screen capture event in this embodiment.

If a screen capture event is detected, the mobile phone captures and stores the DMB image displayed at the time point when the screen capture event is detected in Step 905.

In order for the user to be involved in the short message composition, the mobile phone is provided with DMB data-based short message composition-related function keys or soft keys.

If an automatic capture function is activated, the mobile phone can recognize a character string registered by the user such that the mobile phone detects the character string from the caption of the DMB stream and captures a DMB image with the caption containing the registered character string. The captured DMB image is a frame including raw data.

After storing the captured DMB image, the mobile phone extracts a text from the DMB image in Step 907. Preferably, the text is extracted by a character recognition engine. The extracted text is displayed on an SMS execution screen. Preferably, the SMS execution screen is overlaid on the DMB execution screen according to a multitasking function. While displaying the extracted text on the SMS execution screen, specific parts of the text are designated as a title and contents according to a preset user configuration. For example, the user can set the configuration of the short message composition function such that a first (1) byte or more of the text is designated for the title of the short message and the remaining or whole text for the content of the short message.

After extracting the text from the DMB image, the mobile phone determines whether the length of the text is shorter than or equal to an SMS length limit in Step 909. If the length of the text is shorter than or equal to the SMS length limit, the mobile phone displays the text on the SMS execution screen as a short message in Step 911.

If the length of the text is longer than the SMS length limit, the mobile phone downsizes the length of the text or divides the text into two or more pieces in Step 913, and then displays the downsized or divided text on the SMS execution screen as a short message in Step 911.

After a short message is completely generated, the mobile phone determines whether a send key is input for transmitting the short message in Step 915.

If a send key is input, the mobile phone transmits the short message through an SMS channel along with a destination phone number in Step 917.

If a send key is not input, the mobile phone performs an operation requested by the user in Step 919. For example, the mobile phone allows the user to modify the short message or input a destination phone number at Step 919.

Although example embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

As described above, a DMB data-based short messaging system and method of the present invention extract text from DMB_signals and compose a short message using the extracted text, thereby facilitating composition of a short message. Also, the DMB-data-based short messaging system is advantageous for automatically converting a text contained in a DMB image into a short message for SMS without a user's involvement.

Also, a DMB data-based short messaging system and method of the present invention are advantageous for increasing the utilization efficiency of a DMB-enabled mobile phone by converging DMB and SMS functions.

Further, a DMB data-based short messaging system and method of the present invention are advantageous for simplifying composition of a short message without key-based data input and for improving performances of supplementary functions.

What is claimed is:

1. A short messaging method for a mobile phone supporting digital broadcast service and a short message service, the method comprising:
receiving a broadcast stream;
capturing a broadcast image from the broadcast stream;
extracting text from the broadcast image; and
composing a short message using the text.

2. The short messaging method of claim 1, wherein capturing the broadcast image comprises:
detecting a specific character string from a caption provided with the broadcast stream; and
creating an event for triggering a capture of the broadcast image if the specific character string is detected.

3. The short messaging method of claim 1, wherein capturing the broadcast image comprises:
storing the broadcast image;
extracting a caption from the broadcast image; and
dividing the caption into at least one indexed part consisting of a short message.

4. The short messaging method of claim 3, wherein the broadcast image is captured upon key input command.

5. The short messaging method of claim 3, wherein the broadcast image is captured upon detection of a registered character string contained in the broadcast stream.

6. The short messaging method of claim 3, wherein dividing the caption comprises:
determining whether the caption length is less than or equal to a short message length limit; and
downsizing, if the length of the caption is not less than or equal to the short message length limit, the length of the caption.

7. The short messaging method of claim 1, wherein the short message is transmitted through a Short Message Service (SMS) channel.

8. The short messaging method of claim 1, further comprising:
resizing the text to fit a short message length limit; and
dividing the text into at least two indexed parts of the short message.

9. The short messaging method of claim 1, wherein the broadcast stream is a satellite broadcast stream or a terrestrial broadcast stream.

10. A short messaging method for a mobile phone supporting a digital broadcast service and a short message service, the method comprising:
capturing, if a specific event occurs, broadcast data from a broadcast stream;
extracting text from the broadcast data;
displaying the text on a short message composition screen;
composing a short message using the text; and
transmitting the short message through a short message service.

11. The short messaging method of claim 10, wherein the event is a capture command input by a user.

12. The short messaging method of claim 10, wherein the event is a detection of preset information contained in the broadcast stream.

13. The short messaging method of claim 12, wherein the preset information is a registered character string of a caption of the broadcast stream.

14. The short messaging method of claim 10, wherein displaying the text comprises:
activating the short message composition screen; and
pasting the text in the short message composition screen.

15. The short messaging method of claim 14, wherein pasting the text comprises:
designating a part of the text as a title and all of the text as a content of the short message.

16. The short messaging method of claim 10, wherein displaying the text comprises:
determining whether a length of the text is less than or equal to a short message length limit;
converting, if the length of the text is less than or equal to a short message length limit, the text into a draft short message;
shortening, if the length of the text is not less than or equal to a short message length limit, the text to fit the short message limit; and
converting the shortened text into a draft short message.

17. The short messaging method of claim 10, wherein transmitting the short message comprises:
determining whether a key is input for transmitting the short message; and
transmitting, if the key is input for transmitting the short message, the short message along with target terminal information.

18. The short messaging method of claim 10, wherein the short message is transmitted along with a target phone number.

19. A short messaging system comprising:
a first mobile phone having a digital broadcast module for receiving a broadcast stream, and a short message module for composing a short message using a caption included in the broadcast stream and transmitting the short message; and
a second mobile phone receiving the short message and displaying the short message.

20. The short messaging system of claim 19, wherein the first mobile phone captures a broadcast image from the broadcast stream and composes the short message using the caption included in the broadcast image.

21. The short messaging system of claim 19, wherein the first mobile phone captures a broadcast image from the broadcast stream, extracts a caption from the broadcast image, and composes the short message using the caption.

22. The short messaging system of claim 19, wherein the first mobile phone detects a specific character string from a caption of the broadcast stream; captures, if the specific character string is detected, a broadcast image from the broadcast stream; extracts the caption from the broadcast image; and composes a short message having a title and content using the caption.

23. The short messaging system of claim 19, wherein the first mobile phone captures a broadcast image from the broadcast stream in accordance with a capture command input by a user; extracts a caption from the broadcast image; and composes the short message having a title and a content using the caption.

24. The short messaging system of claim 19, wherein the first mobile phone determines whether the caption has a length shorter than or equal to a short message length limit; shortening, if the length of the caption is not shorter than or equal to the short message length limit, the length of the caption; and writing the shortened caption as content of the short message.

25. The short messaging system of claim 19, wherein the first mobile phone composes the short message using the caption of the broadcast stream and transmits the short message to the second mobile phone through a short message service.

26. The short messaging system of claim 19, further comprising a billing center for performing a billing function on transmission and reception of the short message.

27. The short messaging system of claim 19, wherein the broadcast stream is received through a satellite broadcast channel or a terrestrial broadcast channel.

28. A mobile phone comprising:
a multimedia processing unit for receiving a broadcast stream, and for separating video, audio, and caption signals from the broadcast stream;
a short message processing unit for capturing a broadcast image from the broadcast stream in accordance with a preset configuration and composing a short message using the captured broadcast image; and
a controller for controlling cooperation of the multimedia processing unit and the short message processing unit to detect a character string in the broadcast stream, capture the broadcast image, extract text from the broadcast image, and compose the short message using the text, according to the preset configuration.

29. The mobile phone of claim 28, further comprising a display unit for presenting a short message application execution screen.

30. The mobile phone of claim 28, further comprising a radio communication module for transmitting and receiving a short message in cooperation with a mobile communication network.

31. The mobile phone of claim 28, further comprising a keypad unit having a plurality of keys for inputting commands for capturing the broadcast image and transmitting the short message.

32. The mobile phone of claim 28, further comprising a memory for storing the broadcast stream received by the multimedia processing unit and a short message composition application.

33. The mobile phone of claim 32, wherein the memory stores the broadcast image captured by the multimedia processing unit in accordance with the preset configuration.

34. The mobile phone of claim 32, wherein the memory stores the broadcast image captured at a time point when a capture key is input or when a registered character string is detected from the broadcast stream.

35. The mobile phone of claim 32, wherein the memory stores a data collection program for collecting video, audio, and broadcast information provided for DMB service in accordance with key inputs; a screen capture program for selectively capturing and storing the DMB data in accordance with a user's request; a text extraction program for extracting text from the captured DMB data; an indexing program for assigning indexes to the extracted DMB data; a resizing program for analyzing a size of the captured DMB data and modifying the size of the DMB data to be fit for SMS transmission; a short message generation program for converting the DMB data into at least one short message; and a control program for checking a configuration set for capturing DMB data, detecting text from the DMB data in accordance with the configuration, and controlling the conversion of the DMB data into the short message.

36. The mobile phone of claim 28, wherein the controller controls the multimedia processing unit to capture the broadcast image from the broadcast stream according to the preset configuration, and controls the short message processing unit to extract a caption from the broadcast image and compose the short message using the caption.

37. The mobile phone of claim 28, wherein the controller analyzes a length of the caption and resizes the length of the caption to fit according to the short message length limit.

38. The mobile phone of claim 28, wherein the multimedia processing unit includes at least one of a satellite broadcast reception module and a terrestrial broadcast reception module.

39. The mobile phone of claim 28, wherein the short message processing unit composes the short message using a caption extracted from the captured broadcast image.

40. The mobile phone of claim 28, wherein the short message processing unit composes the short message having a title and content using a caption extracted from the broadcast image.

41. The mobile phone of claim 28, wherein the short message processing unit automatically converts the caption signal into the short message.

42. The mobile phone of claim 28, wherein the short message processing unit composes the short message with a target phone number.
